(19) United States
(12) Patent Application Publication
(10) Pub. No.: US 2019/0320646 A1
(43) Pub. Date: Oct. 24, 2019

(54) Camouflage Covering for Ladderstand

(71) Applicant: Frank C. Dennis, Warsaw, OH (US)

(72) Inventor: Frank C. Dennis, Warsaw, OH (US)

(21) Appl. No.: 16/354,171

(22) Filed: Mar. 15, 2019

Related U.S. Application Data
(60) Provisional application No. 62/643,687, filed on Mar. 15, 2018.

(51) Int. Cl. A01M 31/02

(52) U.S. Cl. CPC A01M 31/025; A01M 31/02

(57) ABSTRACT

The invention relates to camouflaged hunting equipment. It is a cover for the ladder portion of a hunting ladderstand, intended to make the ladder less noticeable to animals and people. The cover collapses almost flat at the bottom of the ladder when not raised. To raise the cover, a hunter attaches cords between the hunter's beltloops and grommets on the top edge of the cover, then climbs up the ladder, bringing the top edge of the cover up the ladder. At the top, the hunter detaches cords from the beltloops, and attaches the cords to rings on top of the ladderstand. When ready to descend, the hunter detaches or loosens cords from the rings, and lets the cover fall to the ground. The cover can also be raised from the ground, if long cords are threaded through the rings on top of the ladderstand.

### BACKGROUND OF THE INVENTION

Hunters gain an advantage over their prey by perching up higher than ground level. Deer, turkeys and other animals are less likely to see, smell or otherwise sense a hunter who is above the animals' sightline. Hunters commonly use a free standing deer stand, which is a seat with long legs and a ladder providing access to the seat from the ground. If an appropriate tree is available, hunters use various mechanisms to climb the tree and attach a seat to the tree. Another option is to use a ladder tree stand which consists of a ladder and a seat which attaches securely to a tree trunk at the seat level.

A ladder tree stand user may wish to camouflage the lower ladder portion of the tree stand, to hide it from animals and people. Ladders on existing tree stands may be painted or otherwise encoated with camouflage design.

### BRIEF SUMMARY OF THE INVENTION

The invention is a cover for the ladder portion of a ladder tree stand. It folds down flat before installation, and is unfolded and pulled up the ladder as the hunter ascends the ladder, then the top edge of the cover is secured at the seat level so that the ladder remains covered for so long as the hunter remains up on the seat.

### BRIEF DESCRIPTION OF THE SEVERAL VIEWS OF THE DRAWINGS

FIG. 1 is a side view of an exemplary ladder tree stand.

FIG. 2 is a front view of an exemplary ladder tree stand, shown against a tree trunk.

FIG. 3 is a front view of the cover shown partially unfolded and extended up the ladder of a tree stand.

FIG. 4 is a front view of the cover almost completely unfolded and extended up the ladder of a tree stand, with the bottom of the cover staked into the ground and the cords slipped through the rings of the seat portion, but not yet secured.

FIG. 5 is a front view of the cover almost fully collapsed on the ground, ready to be pulled up a ladderstick.

FIG. 6 shows a ring which may be attached to the ladderstand at the top, to be used to attach the cords to the top of the ladderstand.

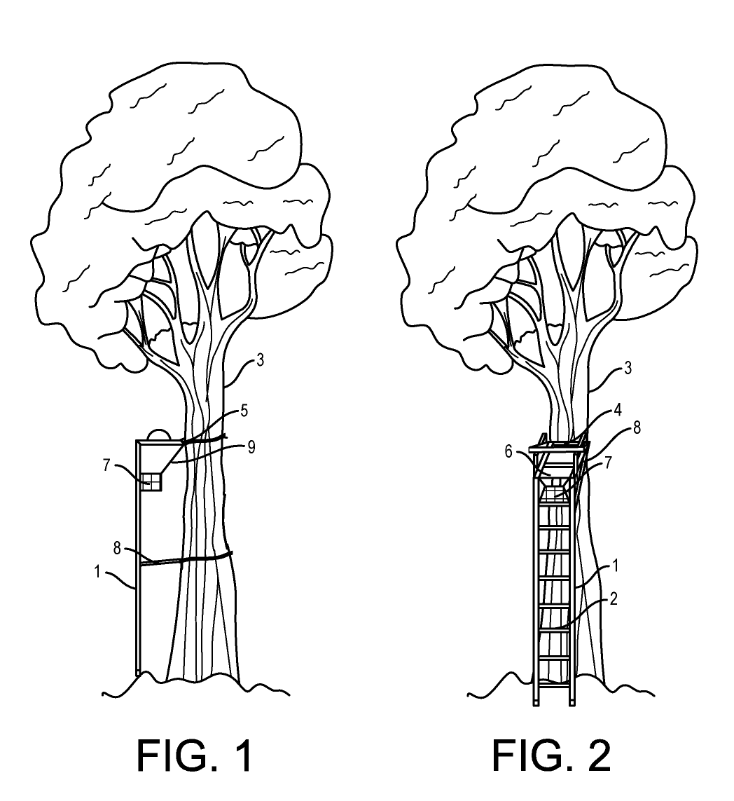

### DETAILED DESCRIPTION OF THE INVENTION

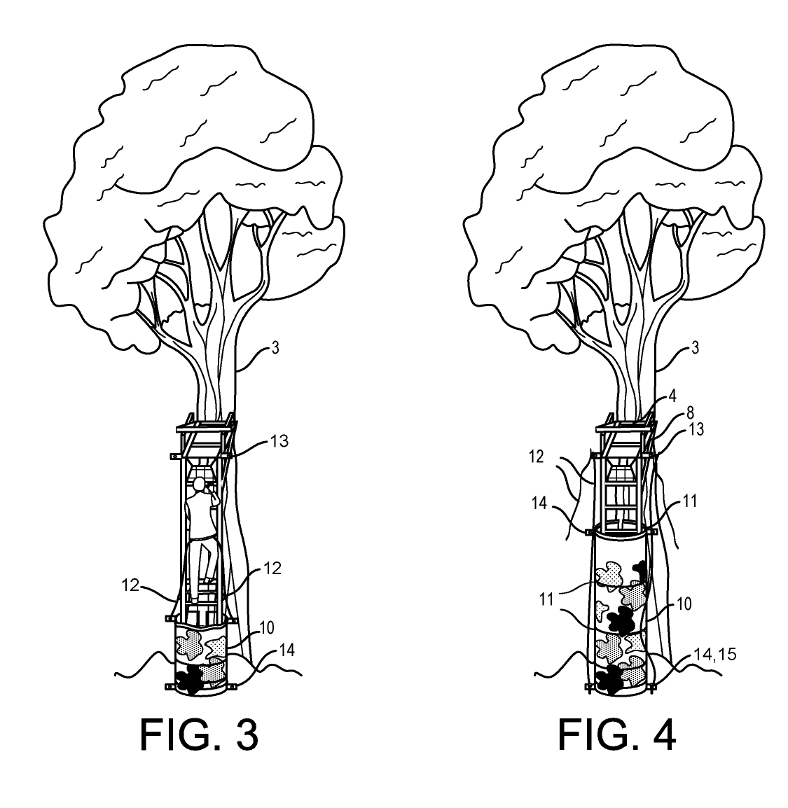

The invention is a cover for the ladder portion of a ladder tree stand. The cover (item 10 in FIGS. 3 and 4) is made of fabric, vinyl, canvas, spunbonded olefin sheet like Tyvek, or other fabric-like material, with hoops 11 sewn or otherwise attached to the material, which hoops have an opening behind the ladder. The hoops 11 may be made of hoop steel, fiberglass, wire, or other material which is flexible but keeps the proper shape. The hoops 11 may be shaped as circles, ovals, rectangles, or similar shapes which will horizontally surround the ladder. A ladder on a ladder tree stand is often 16-20 feet tall, and the cover must be long enough to cover the ladder completely. Hoops are attached to the covering at the bottom and top edges, and then at approximately one foot intervals along the entire covering. Standard ladderstands range from 30 to 60 cm (12-24 inches) wide. The hoops must be wide enough to accommodate whatever width the ladder may be, and able to freely slide up the ladder.

The cover 10 encircles and surrounds the ladder, and has an opening which extends along the entire height of the cover, and which is located in between the ladder and the tree 3 to allow the cover to slide past and fit around any support bar which may extend from the middle of any given ladder step 2 to the tree 3. The cover expands and collapses vertically like an accordion.

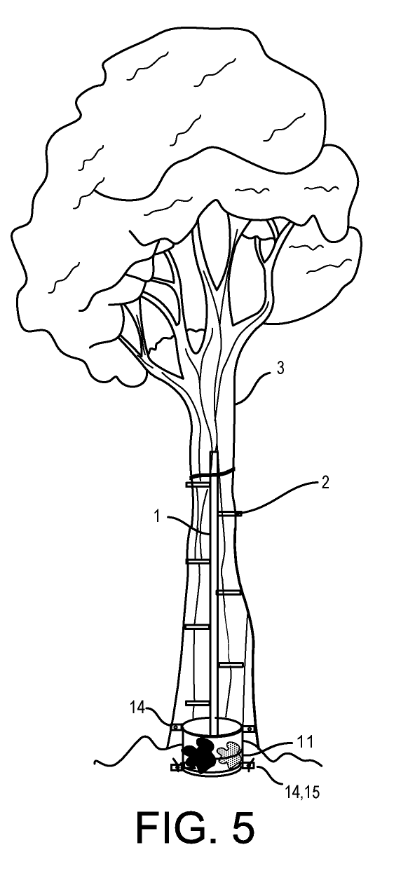

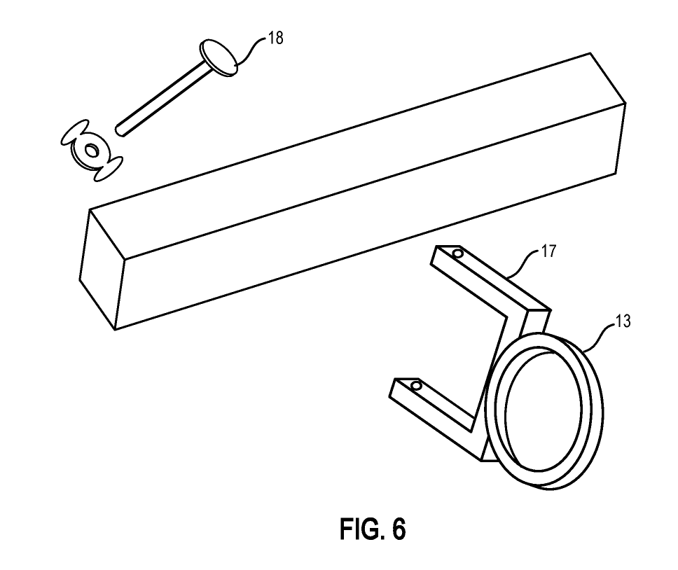

The cover 10, when fully elongated, extends from the ground at the bottom of the ladder up to seat level 6. The cover is installed in its collapsed form, by placing it around the ladder at ground level. When installing the cover, the collapsed cover can be placed on the ground first and the bottom of the ladder then placed inside of the cover (see FIG. 5); or, the ladder can be installed to the tree first, and the collapsed cover then fitted around the ladder by horizontally slipping the cover's back opening past the side rail 1 of the ladder, pulling the cover horizontally past the opposite side rail to cover the bottom of the ladder, then rotating the cover so that its long opening is located between the ladder and the tree trunk 3.

Multiple holes with grommets 14 are located around the bottom edge of the cover, so that the cover can be attached with stakes 15 to the ground through the holes. Two ropes or cords 12 are attached to the top edge of the cover with grommets or other means. When the hunter is ready to climb up to the seat, the hunter steps inside the cover 10 on the ground, and attaches the two cords 12 to belt loops or other convenient places where they may be attached on the hunter's person. The hunter may alternatively hold onto the cords. Then, when the hunter climbs up the ladder, the cover is lifted and extends up the ladder behind the hunter, covering the ladder. For safety, the hunter should allow the cover to stay below his or her feet at least 30 centimeters (a foot), so there is no tripping hazard.

When the hunter reaches the top, he or she pulls the cover up to the desired level at the seat, disconnects the ropes 12 from the belt loops and secures said ropes to rings 13 located on either side of the seat. The hunter can alternatively tie said ropes to convenient places at the top of the ladder or on the seat structure, for example with rings as shown in FIG. 6. The bracket 17 slides onto the arm rest, or gun rail, or other square tubular part of the ladderstand, and is secured with a bolt 18 or pin to complete the square of the bracket.

While seated, the hunter's feet and some portion of the hunter's legs remain inside the cover. When the hunter wishes to climb down the ladder, he or she unties or disconnects the ropes from the rings and either lets the cover fall to the ground on its own, or attaches the ropes to the hunter's belt loops so that the cover descends with the hunter.

If the cords are long enough, the hunter may leave the cords hanging loosely through the rings, and the ends of the cords will hang down far enough such that the hunter can still reach them when the hunter has descended to the ground, and the cover is collapsed at the bottom of the ladder. The hunter can then pull on the cords to pull the cover back up to the top of the ladder, and secure the cords to the ladder or the grommets at the bottom of the ladder, so that the ladder is covered and camouflaged when the hunter is not sitting at the top of the ladder.

The invention can be used in the same way to cover and camouflage a stick ladder, as shown in FIG. 5, or any ladder. A stick ladder has one rail in the center, and the steps extend out to the sides.

1. A cover for a ladder, ladderstand or ladderstick, the cover having a length, a width, a top edge, a bottom edge, an outside surface, an inside surface, and right and left sides:
Said cover being made of fabric or other flexible material; and
Said cover's length being at least as long as the height of the ladder it is intended to cover; and
With a plurality of hoops sewn or otherwise attached to the inside surface of the cover, at intervals from the bottom edge to the top edge of the cover, each hoop being oriented to be parallel with the bottom and top edges of the cover and the ground; and
Each of said hoops having the shape of a circle, rectangle, oval or other shape and a size that fits horizontally around the ladder; and
Each of said hoops having an opening, said opening being situated behind the ladder when the cover is installed on the ladder, which is in the vertical usable position; and
Each of said hoops being made of wire, plastic or other material which is flexible but keeps its shape; and
Said cover having a means for securing the cover to the ground at its bottom edge with stakes, such as grommets; and
Said cover having a means for attaching cords to the top edge of the cover, such as grommets; and
Said cover having two cords attached to the top edge of the cover, at the grommets or other means for attachment.

2. The cover of claim 1, with said cords each having a length which is approximately twice as long as the height of the ladder.

3. The cover of claim 1, with a means for attaching said cords to the top of the ladder, such as rings which may be bolted to the ladder.

4. The cover of claim 2, with a means for attaching said cords to the top of the ladder, such as rings which may be bolted to the ladder.

5. The cover of claim 1, with said hoops being attached about 30 centimeters (1 foot) apart.
